(19) United States
(12) Patent Application Publication
(10) Pub. No.: US 2011/0249850 A1
(43) Pub. Date: Oct. 13, 2011

(54) Acoustic ear tube retainer spring

(76) Inventor: John W. Davis, The Villages, FL (US)

(21) Appl. No.: 13/134,840

(22) Filed: Jun. 20, 2011

Related U.S. Application Data
(63) Continuation-in-part of application No. 11/891,012, filed on Aug. 8, 2007, now abandoned.

(51) Int. Cl. H04R 25/00

(52) U.S. Cl. 381/328

(57) ABSTRACT

A metal retainer spring bent into a forwardly tapered flexible spring for retaining an acoustic ear tube for use with behind-the-ear devices. A rearward hook or tapering slot holds the acoustic ear tube with a friction fit. A forward opening admits the acoustic ear tube therethrough to transmit sound to the eardrum. The ear canal-contacting surfaces of each spring have a friction surface to limit slippage without causing abrasions.

### CROSS-REFERENCE TO RELATED APPLICATIONS

This is a continuation-in-part of utility patent application Ser. No. 11/891,012 filed Aug. 8, 2007.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to ear inserts for hearing aids, acoustic devices, and Bluetooth or hands-free cellular phones and particularly to a metal retainer spring for an acoustic hearing tube for use with behind-the-ear devices, wherein the retainer spring is adapted to fit into the human ear canal for securing a narrow acoustic ear tube device within a user's ear canal and the spring is manufactured from beryllium copper, or other material with excellent strength and great elasticity, and is then gold plated for the hypoallergenic properties, and has a structure to limit slippage in the ear canal without causing abrasion.

2. Description of Related Art including information disclosed under 37 CFR 1.97 and 1.98

Ear molds or ear buds for hearing aids, acoustic devices or cell phones are well known in the art. Currently, there are many ear pieces that are made of silicone or other soft materials. Most of the soft ear pieces have a problem with retention. They are made to be soft so that they will fit into the ear without causing discomfort or irritation, but often do not hold the ear piece securely in place. Ear canal device holders have been proposed which are made of flexible silicone material, such as that found in U.S. Pat. No. 5,572,594 issued to Devoe.

The newest style of hearing aid is called the open fit or the over the ear aid. Processing of sound is done by the device that sits outside the ear canal. The sound is transferred into the canal via a thin tube.

The biggest problem with this style of aid is to get the tube to stay within the ear canal. This is critical to the looks and performance of the device. Every manufacturer has a different style ear mold to hold the tube in place. All the molds are made of silicone or latex.

The molds are soft so that they can conform to the unique shape of the ear canal. Most ear molds are domes or half round spheres. All of them are designed to let air and sound flow into and out of the ear naturally. All current product designs use soft plastic domes, caps or umbrellas. The devices are usually comfortable, but all of them slip out of the ear. Pressure and slippage are problems with snug fitting plastic devices. Most of the soft ear pieces have a problem with retention. The are made to be soft so that they will fit into the ear without causing discomfort or irritation.

If the mold is too tight within the ear canal, it can cause irritation or discomfort. If the mold is made without enough airflow, the user's voice will sound muffled and distorted. If the device is too loose, the mold can slip out of position. Molds out of position can cause feedback: (a high pitch whistle), and the aid will become more conspicuous because of noise the aid is generating. If the mold works it way out of position, the tube then protrudes out and is not cosmetically attractive.

The prior art does not adequately solve all of the problems.

U.S. Pat. No. 7,076,076, issued Jul. 11, 2006 and two U.S. Patent Applications, #20040047483 and #20040047482 published Mar. 11, 2004 all from Bauman, concern a hearing aid system for improving a user's hearing and more particularly a receiver system used in the system. In one embodiment, the receiver system has a housing and a plurality of arms extending from the housing for positioning and suspending the receiver within the ear canal of a user. Each of the arms may be formed from a flexible, plastic material or a bendable wire. In a second embodiment, the receiver system is surrounded by a disc formed from a sound filtering material. When installed in a combination instrument, the receiver is separated from the microphone. When installed in a tinnitus/hyperacusis device, the receiver is separated from the body of the instrument. U.S. Patent Application #20070036374, published Feb. 15, 2007 by Bauman, illustrates a hearing aid system which includes a receiver unit configured and positioned within the user's ear canal so as to minimize insertion loss and/or occlusion effect. With regard to FIGS. 9 and 10, at least one spring is provided on a portion of the receiver unit. When the receiver unit is installed within the ear canal, the spring may contact a wall of the ear canal to facilitate positioning of the receiver unit within the ear canal. Also, multiple springs can be positioned for receiver unit placement inside the ear canal. Such spring may be positioned anywhere on the receiver unit, or indeed, on a portion of the intermediate connecting portion provided within the ear canal.

U.S. Pat. No. #5,572,594, issued Nov. 5, 1996 to Devoe, shows an ear canal device holder for devices other than speaker/microphone amplification systems that are to be inserted into the canal of the human ear. The device holder is made of a flexible silicone material comprising a body and structural support element(s) such that the device is held within the body of the holder and the body and device are secured in the ear by the structural element(s). In addition the device holder minimizes the attenuation of sound waves that pass through the ear canal to the tempanic membrane, while maximizing comfort and secure fit.

U.S. Pat. No. #6,773,405, issued Aug. 10, 2004 to Fraden, is for a continuous body core temperature monitor comprises a pliable ear plug that conforms to the shape of an ear canal and incorporates a temperature sensor that is clamped between the plug and the ear canal wall. The external surface of the plug is connected to an external temperature sensor and a heating element that compensate for a heat lost from the ear canal to the environment by maintaining the temperature gradient between the temperature sensor and the heating element close to zero. Another possible embodiment of the plug is shown in FIG. 5 where the plug is made in shape of flexible fork having a spring action. The end of the fork is squeezed by fingers before the insertion and let go after.

What is needed is an acoustic ear tube retainer spring structured to eliminate the problems of prior art devices

### BRIEF SUMMARY OF THE INVENTION

An object of the present invention is to provide a metal retainer spring for an acoustic hearing tube for use with behind-the-ear devices, wherein the retainer spring is adapted to fit into the human ear canal for securing a narrow acoustic ear tube device within a user's ear canal and the spring is manufactured from beryllium copper, or other material with excellent strength and great elasticity, and is then gold plated for the hypoallergenic properties, and the top and bottom ear canal-contacting surfaces of each spring have a pebbled or rippled finish or spaced coils to limit slippage without causing bruising or abrasion.

Another object of the present invention is to provide a metal retainer spring for an acoustic hearing tube for use with behind-the-ear devices that may be manufactured in a variety of sizes to accommodate various ear canal sizes.

One more object of the present invention is to provide a metal retainer spring for an acoustic hearing tube for use with behind-the-ear devices that is more durable than current in-the-ear devices.

An additional object of the present invention is to provide a metal retainer spring for an acoustic hearing tube for use with behind-the-ear devices that is more adjustable to various ear canal sizes.

In brief, a metal retainer spring retains an acoustic ear tube for use with behind-the-ear devices. The retainer spring fits into the human ear canal for securing a narrow acoustic ear tube device within a user's ear canal. The spring is manufactured from beryllium copper, or other material with excellent strength and great elasticity, and is then gold plated for the hypoallergenic properties. The ear canal-contacting surfaces of each spring have a pebbled or rippled finish or spaced coils to limit slippage without causing bruising or abrasion.

The present invention is structured to eliminate the problems of prior art devices. The spring is made to be taller than it is wide. Ear canals are not perfectly round; most ear canals tend to be oblong. The canal usually has two areas that are smaller that the rest of the canal.

The first narrow portion of the canal is at the very opening of the ear canal. At this position, the greatest amount of flesh is found. This loose skin has a small amount of movement or flexibility.

Most ear canals are slightly over one inch in length. Just before the eardrum or tympanic membrane, there is another narrowness called the isthmus. This area has the least amount of skin covering the bone beneath. Any penetration to or beyond this point usually causes discomfort.

The acoustic ear tube retainer spring of the present invention fits just beyond the opening. It will allow the device to fit in the canal and exert slight expansion up and down on the soft pliable skin. The location of the retainer spring is within the area that has cartilage below the surface of the skin and is not as susceptible to discomfort. The length of the ear spring should give resistance to movement within the ear canal.

The length of the retainer spring is also designed to add comfort to the wearing of the device. Because the retainer spring is exerting pressure on the canal to stay in place, the slight tension is spread over a large area.

To get maximum cosmetic appeal to the device, the inner end of the retainer spring is tapered. This will allow it to penetrate up to the isthmus of the canal. Manufacturers will decide how far they want their tubes to protrude beyond the retainer spring. The device would preferably never protrude more that ⅛ of an inch beyond the hole provided, because of the proximity of the eardrum.

The slots on the exterior ends of the retainer spring are tapered. This allows a tube to be inserted at the widest portion of the opening, then raised up to be locked in place through friction. Because the present invention is made to be universal with all hearing aid manufacturers and telephone and other audio products, each tube has a molded piece on the tube. The molded piece fits between the slots on the exterior and the aperture on the interior of the retainer spring.

An advantage of the present invention is that it retains the acoustic ear tube securely in place without slippage in a portion of the ear canal which does not cause discomfort.

Another advantage of the present invention is that it and admits air and sound into the inner ear.

One more advantage of the present invention is that it eliminates pressure from snug fitting plastic devices and eliminate the slippage that is the most prevalent problem.

An additional advantage of the present-invention is that it is made in a variety sizes to accommodate various different ear canal sizes.

A further advantage of the present invention is that it is more durable than other in-the-ear devices.

A contributory advantage of the present invention is that it is more adjustable than current in-the-ear devices.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a top plan view of the retainer spring of the present invention in a flat configuration prior to bending the retainer spring for use;

FIG. 2 is a side elevational view of the retainer spring of the present invention with the retainer spring in a bent configuration for use;

FIG. 3 is a perspective view of the retainer spring of the present invention with the retainer spring in a bent configuration for use showing an acoustic ear tube inserted through the opening in the curved forward end and the opening formed by bending the two double prong ends together in an overlapping relationship;

FIG. 4 is a perspective view of the retainer spring of the present invention with the retainer spring in a bent configuration for use showing an acoustic ear tube inserted through the opening in the curved forward end and the opening formed by bending the two double prong ends together in an overlapping relationship and showing the retainer spring and acoustic ear tube inserted into an auditory canal shown in partial section;

FIG. 5 is a perspective view of the preferred embodiment of the coiled retainer spring of the present invention showing the coiled spring having a tapered front, cylindrical middle, and a rear protruding looped acoustic ear tube holder and grasping arm;

FIG. 6 is a side elevational view of the preferred embodiment of the coiled retainer spring of FIG. 5; FIG. 7 is a rear end elevational view of the preferred embodiment of the coiled retainer spring of FIG. 5;

FIG. 8 is a top plan view of the preferred embodiment of the coiled retainer spring of FIG. 5;

FIG. 9 is a perspective view of the preferred embodiment of the coiled retainer spring of FIG. 5 with the coiled retainer spring in use showing an acoustic ear tube inserted through the coiled retainer spring and showing the coiled retainer spring and acoustic ear tube inserted into an auditory canal shown in partial section.

### DETAILED DESCRIPTION OF THE INVENTION

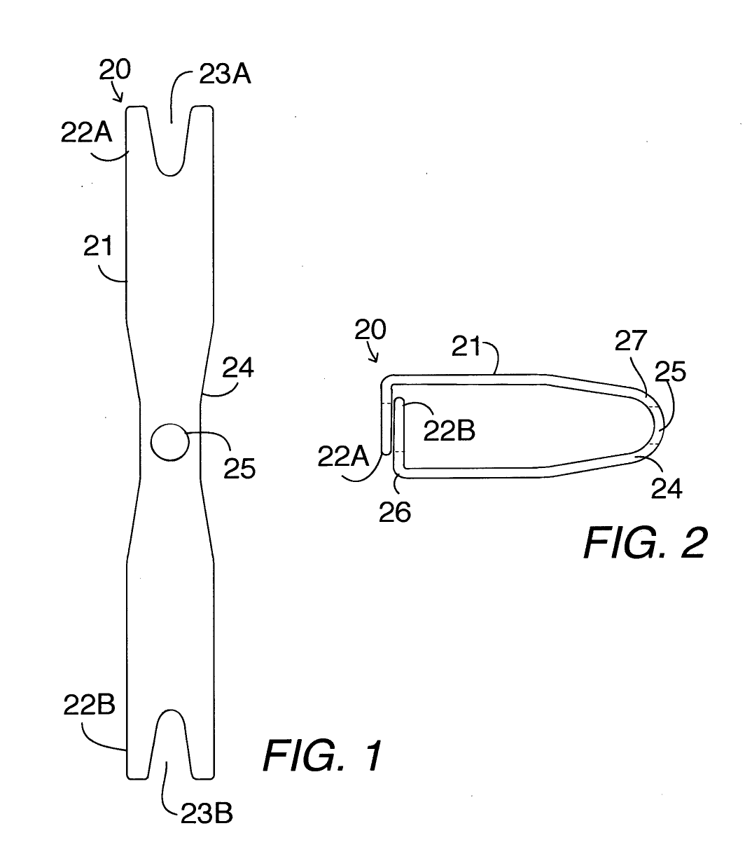

In FIGS. 1-9, an acoustic ear tube retainer spring device comprises a retainer spring 20 and 20A comprising an ear tube retainer shell fabricated of flexible spring metal configured with at least a forward tapering portion 24 and 24A for insertion into an ear canal and at least one wider straight portion 21 and 21 A in alignment with the external auditory meatus 10 of the ear canal, the wider straight portion extending back from the tapering portion. The spaced coils 29A of the straight portion are preferably oval spirals to conform to the external auditory meatus 10 which is taller than it is wide.

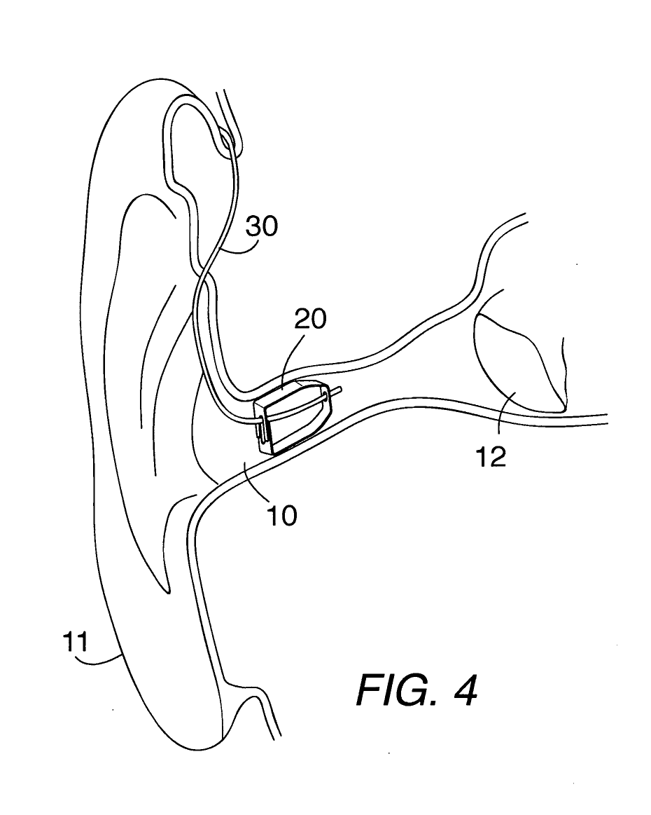

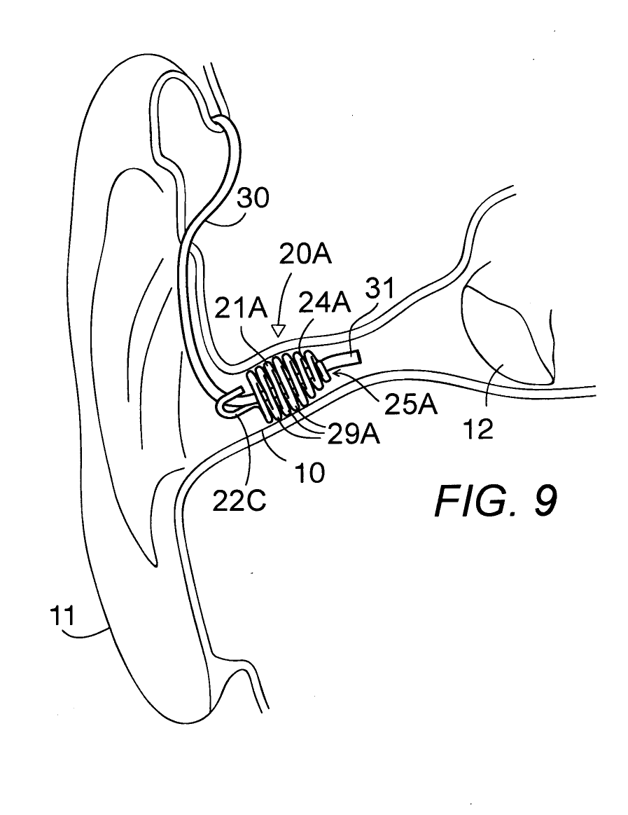

The straight portion 21 and 21 A has a high friction surface for contacting walls of the external auditory meatus 10 of the ear canal with a friction fit to removably lodge the retainer spring therein. The retainer spring further comprises a tube gripping element 22A and 22B, and 22C at a rearward end to retain an acoustic tube 30 held in place within the ear canal. The retainer spring has a hollow interior with at least one forward opening 25 and 25A to admit sound or a sound broadcasting end 31 of the acoustic tube therethrough. The retainer spring 20 and 20A retains an end of the acoustic ear tube 30 within the ear canal in the hollow interior of the retainer spring for transmitting sound from the acoustic tube to an ear drum 12 at an inner end of the ear canal, as shown in FIGS. 4 and 9.

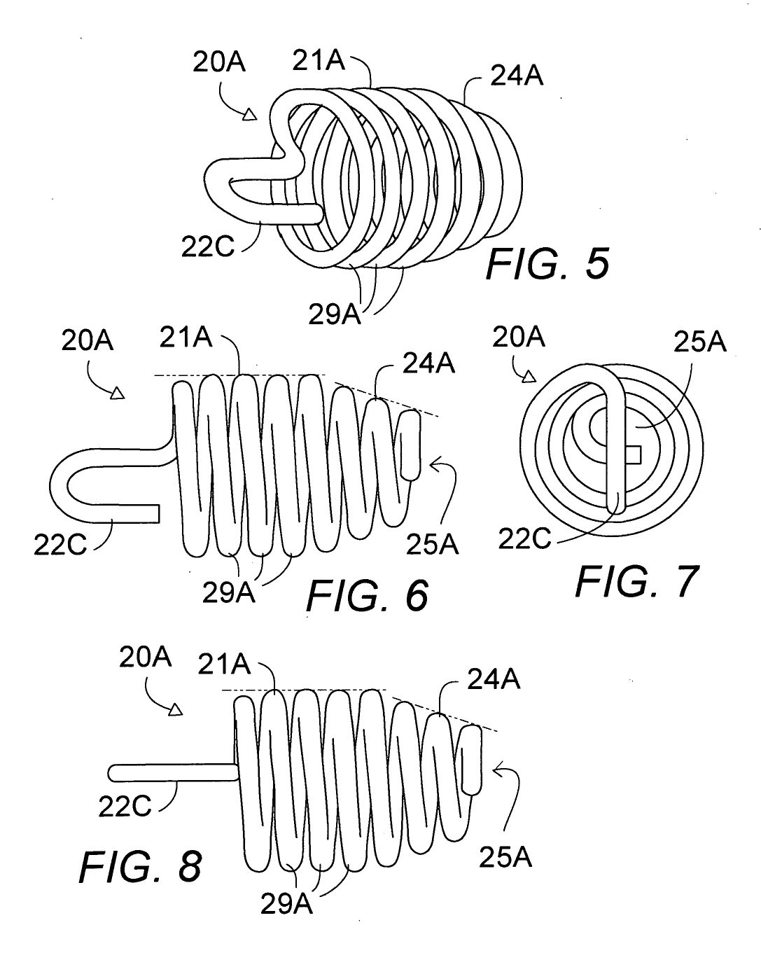

In the preferred embodiment of FIGS. 5-9, the retainer spring 20A comprises a single elongated spring element bent into a three dimensional flexible coil spring configuration of the retainer spring having the front tapering portion 24A and the adjacent straight wider portion 21A.

The elongated spring element 20A is fabricated of a flexible coil spring having a forward end bent into a forward tapering spiral 24A configuration and an adjacent portion bent into a spiral cylindrical portion 21 A having spaced coils 29A, wherein the high friction surface for contacting the walls of the external auditory meatus 10 of the ear canal with a friction fit comprises the spaced coils 29A of the cylindrical portion forming ridges contacting the walls of the external auditory meatus 10 to create a friction fit.

The tube gripping element comprises a rearward protruding U-shaped hook 22C formed in the end of the elongated spring element extending rearwardly from the spiral cylindrical portion 21A, the U-shaped hook configured to secure the acoustic tube 30 between the arms of the U-shaped hook with a tight friction fit, as shown in FIG. 9. The U-shaped hook 22C is positioned adjacent to the outer opening of the ear canal so that the U-shaped hook is a grasping hook that can be grasped by a user to remove the retainer spring from the ear canal.

The flexible coiled retainer spring 20A is preferably fabricated of an elongated element of copper with gold plating bent into the desired shape and size. In FIGS: 1-4, an alternate embodiment of the acoustic ear tube retainer spring device 20 comprises a U-shaped bent retainer spring body 21 with an end opening 25 and bent-over spaced pronged ends 22A and 22B with overlapping tapered end slots 23A and 23B to retain a 1 mm acoustic ear tube 30 in the external auditory meatus of the ear canal 10 of a user's ear 11 spaced apart from the ear drum 12, as shown in FIG. 4.

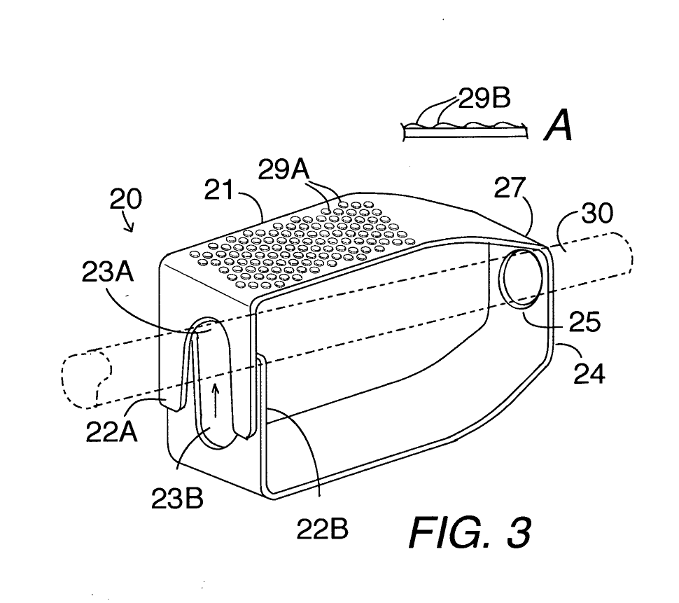

The retainer spring comprises an elongated strip of spring metal having substantially parallel side edges along the length of the elongated strip tapering to a narrow waist in a mid portion 24 having a center opening 25 through the mid portion to admit therethrough and retain therein the acoustic ear tube 30, and an open tapered slot 23A and 23B at each end of the elongated strip. The retainer spring bends into a U-shape for insertion into the ear canal of a user with the mid portion forming the curve 27 of the U-shape, which is inserted first. The parallel side portions contact the top and bottom portions of the external auditory meatus 10 of the ear canal and the two ends 22A and 22B bend inwardly toward each other at bend points 26, as shown in FIG. 2. The tapered end slots 23A and 23B fit over the acoustic ear tube 30, which can be pressed into a narrow portion of one of the tapered end slots 23A to bind the acoustic ear tube to the retainer spring with a friction fit, as shown in FIG. 3, to further assist in retaining the acoustic ear tube 30 with friction, to prevent the acoustic air tube 30 from slipping out of the ear canal while admitting air and sound to pass through the ear canal on both sides of the tapered waist mid portion 24.

The retainer spring is preferably made of beryllium copper for its excellent strength and elasticity, and is gold plated to provide hypoallergenic properties and to provide greater adaptation to body temperature.

The surfaces of the retainer spring that contact the ear canal preferably have textured finishes to limit slippage without causing abrasions. The textured finishes may comprise pebbled finishes 29A, as is FIG. 3, or rippled finishes 29B, as in FIG. 3A.

In use, the acoustic ear tube spring retainer of the present invention is bent into a curve at the mid portion 24, and at the bend points 26 of the two pronged ends 22A and 22B, aligning the two overlapping tapered end slots 23A and 23B, to form a tapered opening that is aligned with the end opening 25. An acoustic ear tube 30 is inserted through the two aligned openings and pressed into a narrow portion of one of the tapered end slots. The bent spring is then inserted into the ear of a user, with the curve 27 of the U-shaped end inserted first, and the parallel side pieces of the spring contacting the top and bottom of the user's ear canal, with a minimum of pressure. The textured surfaces 29A and 29B of the spring device help to secure the device to the soft tissue of the top and bottom of the user's ear canal. By contacting the top and bottom of the ear canal, the spring device avoids the discomfort of possible bruising and abrading the sides of the canal, which have far less soft tissue. The spring device is designed to be used with a high frequency hearing aid or a blue tooth telephone ear piece, or any other device with an acoustic ear tube 30 attached carrying the amplification from the device into the ear canal.

A variety of different sizes of retainer springs can accommodate the various sizes of people's ear canals, with four different sizes accommodating most of the various sizes of ear canals.

It is understood that the preceding description is given merely by way of illustration and not in limitation of the invention and that various modifications may be made thereto without departing from the spirit of the invention as claimed.

What is claimed is:

1. An acoustic ear tube retainer spring device comprising:
a retainer spring comprising an ear tube retainer shell fabricated of flexible spring metal configured with at least a forward tapering portion for insertion into an ear canal and at least one wider straight portion in alignment with the external auditory meatus of the ear canal, the wider straight portion extending back from the tapering portion, the straight portion having a high friction surface for contacting walls of the external auditory meatus of the ear canal with a friction fit to removably lodge the retainer spring therein, the retainer spring further comprising a tube gripping element at a rearward end to retain an acoustic tube held in place within the ear canal, the retainer spring having a hollow interior with at least one forward opening to admit sound therethrough, the retainer spring retaining an end of the acoustic ear tube within the ear canal in the hollow interior of the retainer spring for transmitting sound from the acoustic tube to an ear drum at an inner end of the ear canal.

2. The device of claim 1 wherein the retainer spring comprises a single elongated spring element bent into a three dimensional flexible coil spring configuration of the retainer spring having the front tapering portion and the adjacent straight wider portion.

3. The device of claim 2 wherein the elongated spring element is fabricated of a flexible coil spring having a forward end bent into a forward tapering spiral configuration and an adjacent portion bent into a spiral cylindrical portion having spaced coils wherein the high friction surface for contacting the walls of the external auditory meatus of the ear canal with a friction fit comprises the spaced coils of the cylindrical portion forming ridges contacting the walls of the external auditory meatus to create a friction fit.

4. The device of claim 3 wherein the tube gripping element comprises a rearward protruding U-shaped hook formed in the end of the elongated spring element extending rearwardly from the spiral cylindrical portion, the U-shaped hook configured to secure the acoustic tube between the arms of the U-shaped hook with a tight friction fit.

5. The device of claim 4 wherein the U-shaped hook is positioned adjacent to the outer opening of the ear canal so that the U-shaped hook is a grasping hook that can be grasped by a user to remove the retainer spring from the ear canal.

6. The device of claim 2 wherein the retainer spring is fabricated of an elongated element of copper with gold plating.

7. The device of claim 2 wherein the spaced coils of the straight portion are oval spirals to conform to the external auditory meatus which is taller than it is wide.

8. The device of claim 1 wherein the retainer spring comprises an elongated flexible planar strip of spring metal having substantially parallel side edges along the length of the elongated strip tapering to a narrow waist in a mid portion having a center opening through the mid portion to admit the acoustic ear tube therethrough and retain the acoustic ear tube therein and an open tapered slot at each end of the elongated strip so that the retainer spring bends at the tapered waist portion into a U-shape, the tapered narrow waist portion forming the tapered forward end for insertion into an ear canal of a user, the parallel side portions forming the wider straight portion in alignment with the external auditory meatus of the ear canal, the wider straight portion extending back from the tapering portion, the wirer straight portion contacting a top and bottom portions of the external auditory meatus of the ear canal; and the open tapered slot at each end of the elongated strip bent inwardly so that the two open tapered slots overlap forming a slot therebetween for securing an acoustic ear tube therein with a friction fit and fit over the acoustic ear tube which is pressed against a narrow inner end of one of the tapered slots for a friction fit to assist in retaining the acoustic ear tube to prevent the acoustic air tube from slipping out of the ear canal while admitting air and sound to pass through the ear canal on both sides of the tapered waist mid portion.

9. The device of claim 8 wherein the retainer spring is made of beryllium copper for strength and elasticity. 17 DAVIS

10. The device of claim 8 wherein the retainer spring is gold plated for the hypoallergenic properties.

11. The device of claim 8 wherein the high friction surface of the straight portion comprises a pebbled finish on surfaces contacting the external auditory meatus of the ear canal.

12. The device of claim 8 wherein the high friction surface of the straight portion comprises rippled finishes on surfaces contacting the external auditory meatus of the ear canal.
